(19) United States
(12) Patent Application Publication
(10) Pub. No.: US 2026/0044727 A1
(43) Pub. Date: Feb. 12, 2026

(54) SIGNAL PROCESSING SYSTEM

(71) Applicant: Cirrus Logic International Semiconductor Ltd., Edinburgh (GB)

(72) Inventors: John P. LESSO, Edinburgh (GB); Justin DOUGHERTY, Austin, TX (US); Yanto SURYONO, Tokyo (JP); Toru IDO, Kanagawa (JP)

(73) Assignee: Cirrus Logic International Semiconductor Ltd., Edinburgh (GB)

(21) Appl. No.: 19/203,623

(22) Filed: May 9, 2025

Related U.S. Application Data
(60) Provisional application No. 63/681,192, filed on Aug. 9, 2024.

(51) Int. Cl. G06N 3/065; G06N 5/04

(52) U.S. Cl. CPC G06N 3/065; G06N 5/04

(57) ABSTRACT

A signal processing system configured to receive an input signal and generate an output signal, the signal processing system comprising: an analog inference engine; and a learning engine coupled to the analog inference engine, wherein the signal processing system is operable in a first mode of operation and a second mode of operation, wherein: in the first mode of operation, the analog inference engine is operative to apply weights to the received input signal to generate the output signal; and in the second mode of operation, the analog inference engine is operative to receive a test input signal and process the test input signal to generate a test output signal, and the learning engine is operative to update the weights of the inference engine based on the test output signal.

### FIELD OF THE INVENTION

The present disclosure relates to a signal processing system.

### BACKGROUND

In the field of neural networks, inference engines are critical for processing input signals to generate desired outputs. Conventional neural network-based signal processing systems typically rely on digital inference engines implementing artificial neural networks (ANNs). Digital inference engines can be power-hungry and may require significant computational resources. For these reasons, it may be difficult or impractical to deploy such inference engines in “edge” applications, i.e. applications in which neural network learning or training is performed on a device such as a mobile phone, tablet computer, wearable device (e.g. a smartwatch, a wearable health device or other “smart” device) rather than on a central server, computer or the like.

Additionally, before an inference engine can be used to perform inference on “live” input data, it must be provided with a set of weights, which in use of the inference engine are applied to an input signal to generate an output signal. These weights are typically generated by a learning engine, which is separate to the inference engine and may also require significant computational resources and power. The weights may need to be updated periodically by the learning engine to maintain the accuracy of the output signals of the inference engine. Thus, as shown generally at 100 in FIG. 1, it may be necessary to include both an inference 110 and a learning engine 120 in a host device incorporating a neural network-based signal processing system.

### SUMMARY

According to a first aspect, the invention provides a signal processing system configured to receive an input signal and generate an output signal, the signal processing system comprising: an analog inference engine; and a learning engine coupled to the analog inference engine, wherein the signal processing system is operable in a first mode of operation and a second mode of operation, wherein: in the first mode of operation, the analog inference engine is operative to apply weights to the received input signal to generate the output signal; and in the second mode of operation, the analog inference engine is operative to receive a test input signal and process the test input signal to generate a test output signal, and the learning engine is operative to update the weights of the inference engine based on the test output signal.

The analog inference engine may comprise an analog neural network.

The analog inference engine may be implemented with programmable impedance hardware elements.

The programmable impedance hardware elements may comprise resistive RAM elements, memristors, charge trap transistors or any combination thereof.

Impedances of the programmable impedance hardware elements may act as the weights of the analog inference engine.

The learning engine may be operative to update the weights of the analog inference engine using an updating method comprising first and second forward passes.

The updating method may comprise: in the first forward pass, generating, by the learning engine, a first goodness score for each layer of the analog inference engine based on an output generated by the analog inference engine from a first set of test input data; and in the second forward pass, generating, by the learning engine, a second goodness score for each layer of the analog inference engine based on an output generated by the analog inference engine from a second set of test input data; and updating, by the learning engine, the weights of each layer of the analog inference engine based on the first and second goodness scores.

The first set of test input data may comprise data for which the analog inference engine should generate a positive output. The second set of test input data may comprise data for which the analog inference engine should generate a negative output. The learning engine may be operative to update the weights of each layer of the analog inference engine to increase the first goodness score and decrease the second goodness score.

The learning engine may be operative to update the weights of the analog inference engine using an error diffusion technique.

The learning engine may be operative to: determine weight updates based on a difference between an expected output of the analog inference engine for a test input and an actual output of the analog inference engine for the test input; and apply the weight updates to weights of the analog inference engine.

The signal processing system may further comprise a digital to analog converter (DAC) for converting a digital input signal to an analog input signal for processing by the analog inference engine.

The signal processing system may further comprise an input multiplexer for selectively coupling an input of the DAC to either a test input signal source or a live input signal source according to the mode of operation of the signal processing system.

The signal processing system may further comprise an input multiplexer for selectively coupling an input of the analog inference engine to either an output of the DAC or an analog input signal source according to the mode of operation of the signal processing system.

The signal processing system may further comprise an analog to digital converter (ADC) for converting an analog output signal generated by the analog inference engine in response to an analog input signal into a digital output signal.

The signal processing system may further comprise a demultiplexer for selectively coupling the output of the ADC to either the learning engine or a downstream component or system according to the mode of operation of the signal processing system.

The learning engine may comprise: a subtractor operative, in the second mode of operation, to subtract a signal indicative of the test output signal from a signal indicative of an expected output of the analog inference engine responsive to receiving the test input signal to generate an error signal; and a weight update processing block or module operative to generate a weight update to be applied to weights of the analog inference engine based on the error signal.

The learning engine may be operative to limit or restrict a magnitude of a weight update for updating the weights of the analog inference engine or to limit or restrict a rate at which the weights of the analog inference engine are updated.

According to a second aspect, the invention provides an integrated circuit implementing the signal processing system of the first aspect.

According to a third aspect, the invention provides a host device comprising the signal processing system of the first aspect.

The host device may comprise a wearable device, a wearable health monitor, a continuous glucose monitor, a smart watch, a mobile telephone, an Internet of Things (IoT) device, a sensor, an embedded system, a laptop, notebook, netbook or tablet computer, a gaming device, a games console, a controller for a games console, a virtual reality (VR) or augmented reality (AR) device, a portable audio player, a portable device, an accessory device for use with a laptop, notebook, netbook or tablet computer, a gaming device, a games console a VR or AR device, a mobile telephone, a portable audio player or other portable device.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a signal processing system comprising an inference engine and a learning engine;

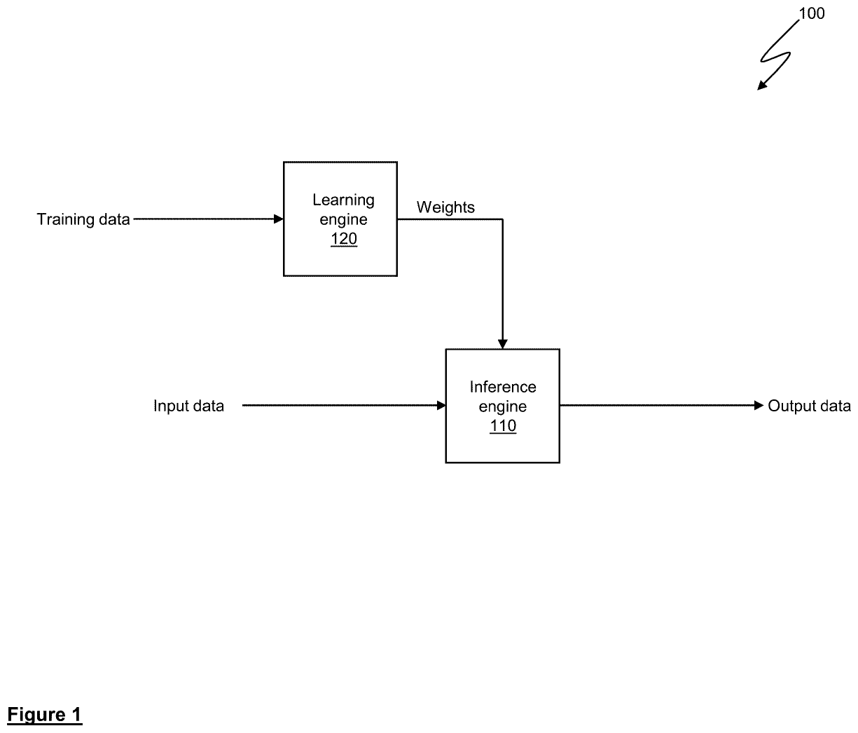

FIG. 2 is a schematic representation of a signal processing system according to the present disclosure;

FIG. 3 illustrates operation of the signal processing system of FIG. 2 in an inference mode of operation;

FIG. 4 illustrates operation of the signal processing system of FIG. 2 in an update mode of operation;

FIG. 5 is a schematic representation of an alternative signal processing system according to the present disclosure;

FIG. 6 illustrates operation of the signal processing system of FIG. 5 in an inference mode of operation;

FIG. 7 illustrates operation of the signal processing system of FIG. 5 in an update mode of operation;

FIG. 8 is a schematic representation of a further alternative signal processing system according to the present disclosure;

FIG. 9 is a schematic representation of a further alternative signal processing system according to the present disclosure;

FIG. 10 is a schematic representation of a further alternative signal processing system according to the present disclosure; and

FIG. 11 is a schematic diagram showing a signal processing system according to the present disclosure that can be configured to receive an analog or digital input signal and to output an analog or digital signal in operation in an inference mode of operation.

### DETAILED DESCRIPTION

Analog inference engines offer a lower-power alternative to digital inference engines, but may present challenges in updating neural network weights efficiently.

The present disclosure proposes a signal processing system including an analog inference engine such as an analog neural network (i.e. an artificial neural network implemented in analog circuitry) and a learning engine coupled to the analog inference engine.

The signal processing system is operable in a first mode, which may be referred to as an inference mode, to process an input signal by applying one or more weights to the input signal to generate an output signal. The signal processing system is also operable in a second mode, which may be referred to as an update mode, in which a known test input signal is supplied to the inference engine, which processes the test input signal by applying one or more weights to the test input signal to generate a test output signal. The learning engine updates the weights of the inference engine based on the test output signal.

Thus, in the signal processing system of the present disclosure the low power consumption analog inference engine can be used for both inference and weight updating/learning, and the learning engine permits robust weight updating. This arrangement thus avoids the need for separate computationally expensive and power-hungry digital engines for inference and weight updating/learning.

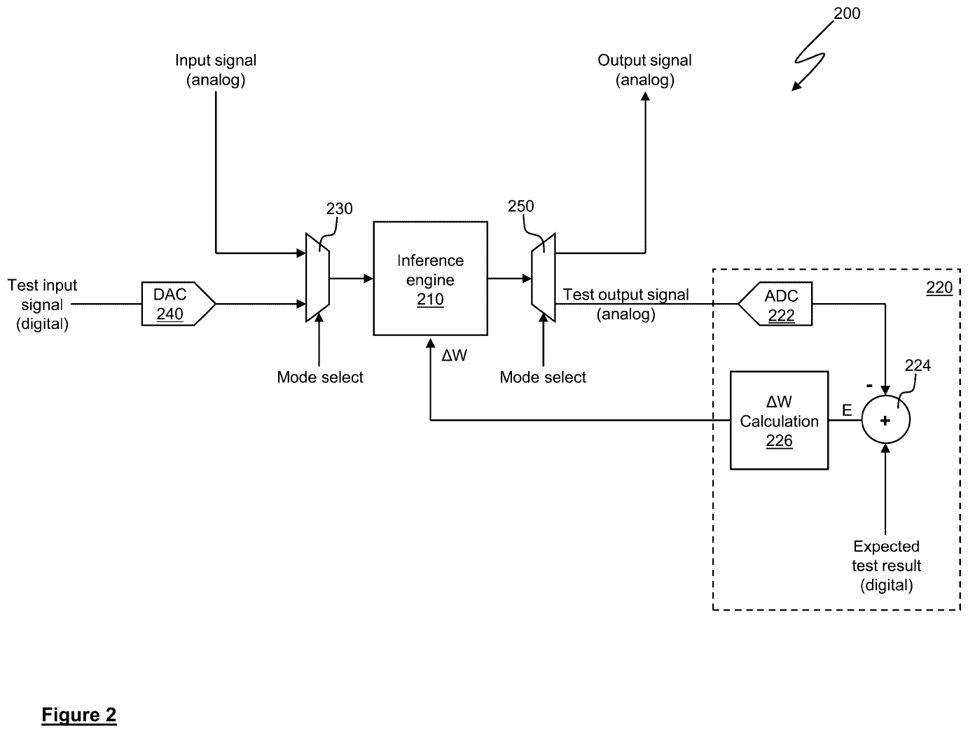

FIG. 2 is a schematic representation of a signal processing system according to the present disclosure.

The signal processing system, shown generally at 200 in FIG. 2, includes an analog inference engine 210, which may comprise, for example, an analog neural network (ANN). The ANN may be implemented in analog circuitry using hardware elements having programmable or impedances. For example, the ANN may be implemented by a set of memristors or other resistive random access memory (RRAM) devices, or by a set of charge-trap transistors (CTTs) arranged or configured as programmable impedance elements, or by other variable or programmable impedance hardware elements. Examples of ANNs having memristor-based or CTT-based structures may be seen in U.S. Pat. No. 11,696,452 or US Patent Application no. 18.600, 957, the contents of which are incorporated by reference herein. The programmable impedance elements permit programmable weights to be applied to signals received by the ANN, with the impedances of the programmable impedances acting as the weights. The analog inference engine 210 may be implemented in an integrated circuit (IC) or in discrete circuitry.

The signal processing system 200 further includes a digital learning engine 220 coupled to the analog inference engine 210. The digital learning engine 220 is operable, in an update mode of operation of the signal processing system, to update the weights of the analog inference engine 210.

In the example illustrated in FIG. 2, the digital learning engine 220 comprises an analog to digital converter (ADC) 222 having an output coupled to a first input of a subtractor 224, and a weight update processing block or module 226 having an input coupled to an output of the subtractor 224. The subtractor 224 and the weight update processing block or module 226 may be implemented using any suitable processing circuitry, e.g. in an IC such as a digital signal processor (DSP) IC, a general purpose processor or a suitably configured application specific integrated circuit (ASIC), or in discrete circuitry. The digital learning engine 220 may be implemented in an IC (e.g. the same IC as the analog inference engine 210, or a separate IC) or in discrete circuitry.

The ADC 222 is operative to convert an analog signal received from an output of the analog inference engine 210 into a digital ADC output signal, which is output to the first input of the subtractor 224. A second input of the subtractor 224 receives a digital expected test result signal, indicative of an expected output of the analog inference engine 210 when a known test signal is input to the analog inference engine 210.

The subtractor 224 is operative to subtract the digital ADC output signal received from the ADC 222 from the digital expected test result signal to generate an error signal E, indicative of a difference between the expected output of the analog inference engine 210 for a given known test input signal and the actual output of the analog inference engine 210 for that test input signal. The error signal E is output to the weight update processing block or module 226. The weight update processing block or module 226 generates a weight update signal ΔW, indicative of updated weights for the analog inference engine 210, as will be discussed in more detail below. The weight update signal ΔW is output to the analog inference engine 210 to update the weights of the analog inference engine 210.

The signal processing system 200 further includes an input multiplexer 230 for selecting between input signals to the signal processing system 200. Thus, the input multiplexer 230 has an output coupled to an input of the analog inference engine 210, a first input for receiving a “live” input signal, a second input for receiving a test input signal, and a control input for receiving a mode select signal that controls which of the inputs of the input multiplexer 230 is coupled to the output of the input multiplexer 230, according to a mode of operation of the signal processing system 200.

In the example shown in FIG. 2, the “live” input signal is an analog input signal to the signal processing system 200 for processing by the analog inference engine 210, and may be, for example, an analog output signal from an analog sensor or transducer, or an analog output signal from a preceding analog neural network.

In the example shown in FIG. 2, the test input signal is a digital signal. Thus, the signal processing system 200 in this example includes an input digital to analog converter (DAC) 240 for converting the digital test input signal into an analog test input signal that can be processed by the analog inference engine 210. However, in other examples the test input signal may be an analog input signal. In such examples the input DAC 240 is omitted or bypassed.

The signal processing system 200 further includes an output demultiplexer 250 for selectively outputting an output signal of the analog inference engine 210 to either a downstream element, which may be, for example, an analog transducer or further analog processing circuitry such as a following analog neural network (or a following layer of an analog neural network), or to the digital learning engine 220. Thus, the output demultiplexer 250 has an input coupled to an output of the analog inference engine 210, a first output for coupling to the downstream element, a second output coupled to an input of the digital learning engine 220, and a control input for receiving the mode select signal, which controls which of the outputs of the output demultiplexer 250 is coupled to the input of the output demultiplexer 250, according to the mode of operation of the signal processing system 200.

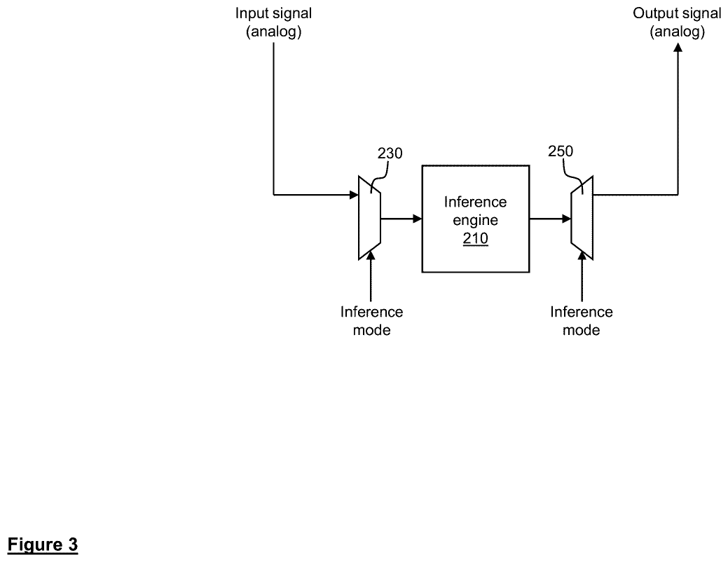

FIG. 3 illustrates the operation of the signal processing system 200 of FIG. 2 in an inference mode of operation.

The digital learning engine 220 is not used in the inference mode of operation, and thus the digital learning engine 220 and the digital test input signal, input DAC 240 and analog test output signal are not shown in FIG. 3.

In the inference mode of operation, a “live” analog input signal is supplied to the signal processing system 200 for processing by the analog inference engine 210, and an output signal is generated by the analog inference engine 210 for output to a downstream element. The mode select signal supplied to the control input of the input multiplexer 230 and to the control input of the output demultiplexer 250 is indicative that the signal processing system 200 is to operate in the inference mode of operation. Responsive to this mode select signal, the input multiplexer 230 selects its first input, such that the “live” analog input signal is output to the analog inference engine 210 for processing. The output demultiplexer 250 selects its first output, such that the output signal generated by the analog inference engine 210 is output to the downstream element.

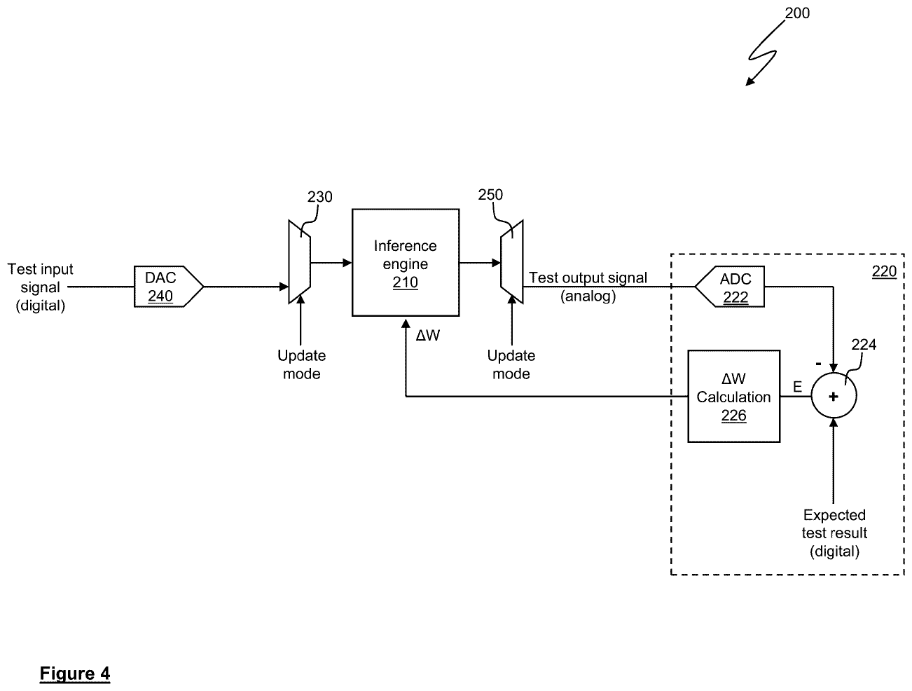

FIG. 4 illustrates operation of the signal processing system of FIG. 2 in an update mode of operation.

The analog input signal and the analog output signal are not used in the update mode of operation, and thus these signal as are not shown in FIG. 4.

In the update mode of operation, a known digital test input signal (which may be generated or output by the digital learning engine 220, in some examples) is supplied to the signal processing system 200 and the signal output by the analog inference engine 210 in response to the test input signal is compared to an expected output of the analog inference engine 210. Any difference between the signal output by the analog inference engine 210 and the expected output is used by the digital learning engine 220 to calculate any required weight updates to be applied to the weights of the analog inference engine 210.

Thus, in the update mode of operation, the mode select signal supplied to the control input of the input multiplexer 230 and to the control input of the output demultiplexer 250 is indicative that the signal processing system 200 is to operate in the update mode of operation. Responsive to this mode select signal, the input multiplexer 230 selects its second input, such that the analog version of the digital test input signal (output by the input DAC 240) is output to the analog inference engine 210 for processing. The output demultiplexer 250 selects its second output, such that the output signal generated by the analog inference engine 210 is output to the digital learning engine 220.

The subtractor 224 of the digital learning engine 220 generates the error signal E and outputs it to the weight update processing block or module 226, as described above with reference to FIG. 2. Based on the error signal E, the weight update processing block or module 226 generates the weight update signal ΔW for updating the weights of the analog inference engine 210.

The weight update processing block or module 226 may update the weights of the analog inference engine based on a Forward-Forward (FF) technique such as Hinton's Forward-Forward technique, or based on an error diffusion (ED) technique such as Isamu Kaneko's Error Diffusion technique, adapted for neural network updating. The use of such techniques simplifies the design of the signal processing system 200, as they are less complex than other techniques for updating weights, such as back propagation.

FF techniques such as Hinton's technique aim to train a neural network such that all the layers of the neural network exhibit high activity when the desired output is positive and low activity when the desired output is negative. This activity is measured by the magnitude of the neurons of the neural network.

An FF technique simplifies the learning process by focusing on two forward passes instead of the forward and backward passes used in Back Propagation techniques.

In one example that uses an FF technique, in the update mode of operation, the signal processing system 200 performs first and second forward passes of training or test data.

In the first forward pass, a first set of known input training or test data is supplied to the signal processing system 200 (e.g. by the digital learning engine 220) as a set of input signals for processing by the analog inference engine 210. The first set of training or test data supplied to the signal processing system in the first forward pass is real data for which the analog inference engine 210 (or a layer of the analog inference engine 210) should generate a positive output. For each layer of the analog inference engine 210, the weight update processing block or module 226 calculates a first “goodness” score based on the error signal E output by the subtractor 224 for the output of that layer. The first “goodness” score is indicative of how well the output of the layer aligns with an expected output of the layer for the corresponding input of the first set of known input training or test data.

In the second forward pass, a second set of known input training or test data is supplied to the signal processing system 200 (e.g. by the digital learning engine 220) as a set of input signals for processing by the analog inference engine 210. The second set of training or test data supplied to the signal processing system in the second forward pass is synthetic data for which the analog inference engine 210 (or a layer of the analog inference engine 210) should generate a negative output. The second set of training or test data may be, for example, noisy or shuffled versions of the real data of the first set of training or test data. The first set of known input training or test data and the second set of known input training or test data may be balanced, such that the number of negative outputs generated in the second forward pass is equal to the number of positive outputs generated in the first forward pass.

For each layer of the analog inference engine 210, the weight update processing block or module 226 calculates a second “goodness” score based on the error signal E output by the subtractor 224 for the output of that layer. The second “goodness” score is indicative of how well the output of the layer aligns with an expected output of the layer for the corresponding input of the second set of known input training or test data.

The weight update processing block or module 226 determines weight updates to be applied to each layer of the analog inference engine 210 to increase the first goodness score of the positive outputs generated in the first forward pass and to decrease the second goodness score of the negative outputs generated in the second forward pass. A weight update signal ΔW indicative of determined weight updates to be applied to each hidden layer of the analog inference engine 210 is output by the by the weight update processing block or module 226 to the analog inference engine 210 to update the weights of the analog inference engine 210 for subsequent processing of “live” input signals in the inference mode of operation of the signal processing system 200.

Thus, in the FF technique described above, an error between an actual output and an expected output is calculated per layer of the analog inference engine 210, and weight updates are determined and applied to the analog inference engine 210 on a per-layer basis.

Error diffusion techniques train a neural network to ensure the output of the neural network matches an expected result (for a given input) by adjusting all the layers of the neural network based on a common error or delta, which is defined as the difference between the output of the network and the expected or desired output. Since all the layers of the neural network are updated with the same error, this approach is described as diffusing the or broadcasting a global error or delta.

In one example that uses an error diffusion technique, in the update mode of operation, the signal processing system 200 performs a forward pass of training or test data to determine a global error between an actual output and an expected output of the analog inference engine 210 for the training or test data. Based on this error, a global weight update to be applied to all the weights of the analog inference engine 210 is determined and applied by the weight update processing block or module 226.

Thus, input training or test data is supplied (e.g. by the digital learning engine 220) to the signal processing system 200 as an input signal for processing by the analog inference engine 210. The analog inference engine 210 generates an output signal based on the input signal. The subtractor 224 of the digital learning engine 220 generates an error signal E indicative of a difference between the actual output signal generated by the analog inference engine 210 and an expected output signal for the test or training data, and outputs it to the weight update processing block or module 226.

Based on the error signal E, the weight update processing block or module 226 calculates weight update values which, if applied to weights in the analog inference engine 210, would minimise the error between the actual output signal generated by the analog inference engine 210 and an expected output signal for the test or training data. The weight update processing block or module 226 generates weight updates AW r and outputs them to the analog inference engine 210 to update the weights of the analog inference engine 210 for subsequent processing of “live” input signals in the inference mode of operation of the signal processing system 200.

As will be apparent from the foregoing discussion, the distinct training objectives between the FF and error diffusion methods lead to notable differences: the forward-forward method requires a normalisation layer between layers and cannot output specific target values beyond binary, while the error diffusion method does not require normalisation layers and can be trained to produce outputs that match any expected value, allowing for multi-level outputs.

In some applications, it may be desirable to limit or restrict the magnitude of the weight updates applied to the weights of the analog inference engine 210, or to limit or restrict a rate at which the wights of the analog inference engine 210 are updated. This may be achieved, for example, by applying a gain term to the error signal E (e.g. in the processing block or module 226).

It may also be desirable to raise a flag, alert or error message if a weight update is of a magnitude greater than a predetermined threshold magnitude. Thus, the processing block or module 226 may be operative to compare the error signal E to a predetermined error signal threshold, and to output a flag signal (e.g. to a main processor of a host device incorporating the signal processing system 200) if the error signal E meets or exceeds the predetermined error signal threshold. Alternatively, the processing block or module 226 may be operative to compare a magnitude of a determined weight update to a predefined weight update magnitude threshold, and to output a flag signal (e.g. to a main processor of a host device incorporating the signal processing system 200) if the magnitude of the determined weight update meets or exceeds the predetermined weight update magnitude threshold.

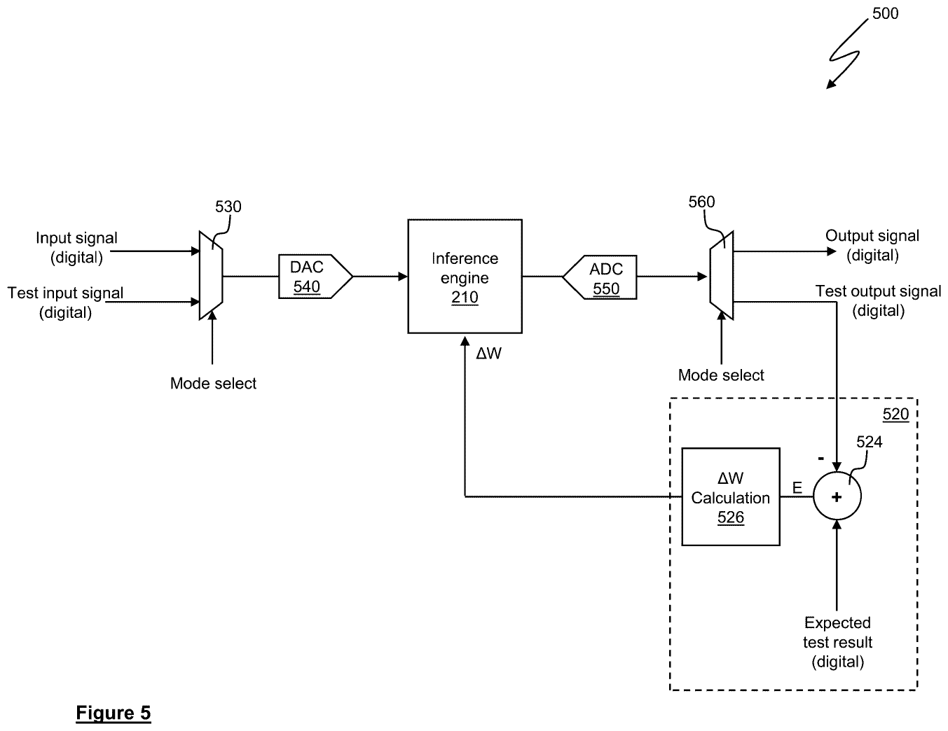

FIG. 5 is a schematic representation of an alternative signal processing system according to the present disclosure.

This alternative signal processing system, shown generally at 500 in FIG. 5, includes an analog inference engine 210 of the kind described above with reference to FIG. 2.

The signal processing system 500 further includes a digital learning engine 520 coupled to the analog inference engine 210 and operable, in an update mode of operation of the signal processing system 500, to update the weights of the analog inference engine 210.

The digital learning engine 520 comprises a subtractor 524 and a weight update processing block or module 526. The subtractor 522 receives, at a first input, a digital test output signal, and at a second input, a digital expected test result signal, indicative of an expected output of the analog inference engine 210 when a known test signal is input to the analog inference engine 210. An output of the subtractor 524 is coupled to an input of the weight update processing block or module 526. The subtractor 524 and the weight update processing block or module 526 may be implemented using any suitable processing circuitry, e.g. in an IC such as a digital signal processor (DSP), a general purpose processor or a suitably configured application specific integrated circuit (ASIC), or in discrete circuitry. The digital learning engine 520 may be implemented in an IC (e.g. the same IC as the analog inference engine 210, or a separate IC) or in discrete circuitry.

The subtractor 524 is operative to subtract the digital test output signal from the digital expected test result signal to generate an error signal E, indicative of a difference between the expected output of the analog inference engine 210 for a given known test input signal and the actual output of the analog inference engine 210 for that test input signal. The error signal E is output to the weight update processing block or module 526. The weight update processing block or module 526 generates a weight update signal AW, indicative of updated weights for the analog inference engine 210. The weight update signal ΔW is output to the analog inference engine 210 to update the weights of the analog inference engine 210, using an FF or error diffusion technique as described above with reference to FIG. 4.

The signal processing system 500 further includes an input multiplexer 530 for selecting between digital input signals to the signal processing system 500. The selected digital input signal must be converted to an analog signal for processing by the analog inference engine 210. Thus, the input multiplexer 530 has an output coupled to an input of an input DAC 540, and an output of the input DAC 540 is coupled to an input of the analog inference engine 210. The input multiplexer 530 also has a first input for receiving a “live” input signal, a second input for receiving a test input signal, and a control input for receiving a mode select signal that controls which of the inputs of the input multiplexer 530 is coupled to the output of the input multiplexer 530, according to a selected mode of operation of the signal processing system 500.

Coupling the input DAC 540 between the output of the input multiplexer 530 and the input of the analog inference engine 210 as shown in FIG. 5 is beneficial because it obviates the need for separate DACs at the inputs of the input multiplexer 530, but it will be appreciated that the single-input DAC 540 could be replaced by separate DACs on the input side of the input multiplexer 530, having outputs coupled to the inputs of the input multiplexer 530.

The signal processing system 500 further includes an output ADC 550 for converting an analog output signal output by the analog inference engine 210 to a digital output signal, and an output demultiplexer 560 for selectively outputting this digital output signal to either a downstream element, which may be, for example, a digital transducer or further digital processing circuitry, or to the digital learning engine 520. Thus, the output demultiplexer 460 has an input coupled to an output of the output ADC 550, a first output for coupling to the downstream element, a second output coupled to an input of the digital learning engine 520, and a control input for receiving the mode select signal, which controls which of the outputs of the output demultiplexer 460, is coupled to the input of the output demultiplexer 560, according to the selected mode of operation of the signal processing system 500.

Coupling output ADC 550 between the output of the analog inference engine 210 and the input of the output demultiplexer 560 as shown in FIG. 5 is beneficial because it obviates the need for separate DACs at the outputs of the output demultiplexer 560, but it will be appreciated that the single output DAC 550 could be replaced by separate DACs having inputs coupled to the outputs of the output demultiplexer 560.

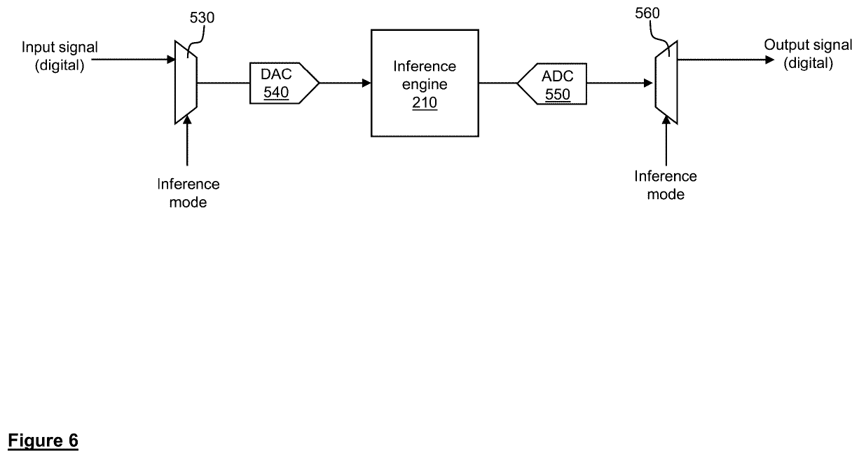

FIG. 6 illustrates the operation of the signal processing system 500 of FIG. 5 in an inference mode of operation.

The digital learning engine 520 is not used in the inference mode of operation, and thus the digital learning engine 520 and the digital test input signal and digital test output signal are not shown in FIG. 6.

In the inference mode of operation, a “live” digital input signal is supplied to the signal processing system 500 for processing by the analog inference engine 210, and an output signal is generated by the analog inference engine 210 for output to a downstream element. The mode select signal supplied to the control input of the input multiplexer 530 and to the control input of the output demultiplexer 560 is indicative that the signal processing system 500 is to operate in the inference mode of operation. Responsive to this mode select signal, the input multiplexer 530 selects its first input, such that the “live” digital input signal is output to input DAC 540, which outputs an analog version of the digital input signal to the analog inference engine 210 for processing. The output ADC 550 converts an analog output signal generated by the analog inference engine 210 into a digital output signal, and the output demultiplexer 560 selects its first output, such that the digital output signal output by the output ADC 550 is output to the downstream element.

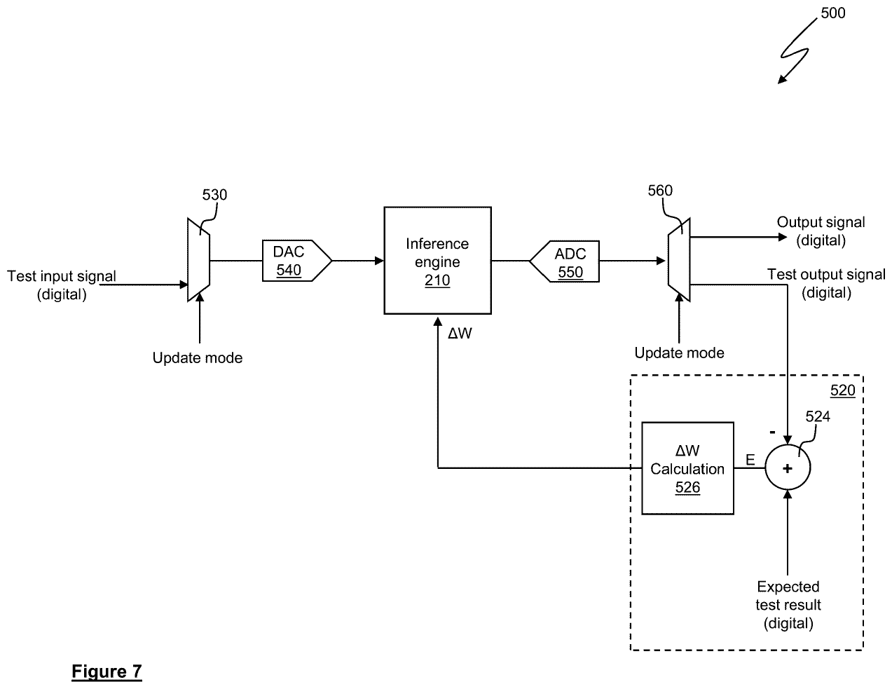

FIG. 7 illustrates operation of the signal processing system of FIG. 5 in an update mode of operation.

The analog input signal and the analog output signal are not used in the update mode of operation, and thus these signal as are not shown in FIG. 7.

In the update mode of operation, a known digital test input signal is supplied to the signal processing system 200 and the signal output by the analog inference engine 210 in response to the test input signal is compared to an expected output of the analog inference engine 210. Any difference between the signal output by the analog inference engine 210 and the expected output is used to calculate any required updates to the weights of the analog inference engine 210.

Thus, in the update mode of operation, the mode select signal supplied to the control input of the input multiplexer 530 and to the control input of the output demultiplexer 560 is indicative that the signal processing system 500 is to operate in the update mode of operation. Responsive to this mode select signal, the input multiplexer 530 selects its second input, such that digital test input signal is output to the input DAC 540, which in turn outputs an analog version of the digital test input signal to the to the analog inference engine 210 for processing. The output ADC 550 converts an analog output of the analog inference engine 210 into a digital output signal, which is output to the output demultiplexer 560. The output demultiplexer 560 selects its second output, such that the digital output signal generated by the output ADC 550 analog inference engine 210 is output to the digital learning engine 520.

The subtractor 524 of the digital learning engine 520 generates the error signal E and outputs it to the weight update processing block or module 526 as described above with reference to FIG. 2. Based on the error signal E, the weight update processing block or module 526 generates the weight update signal ΔW for updating the weights of the analog inference engine 210, in the manner described above with reference to FIG. 4.

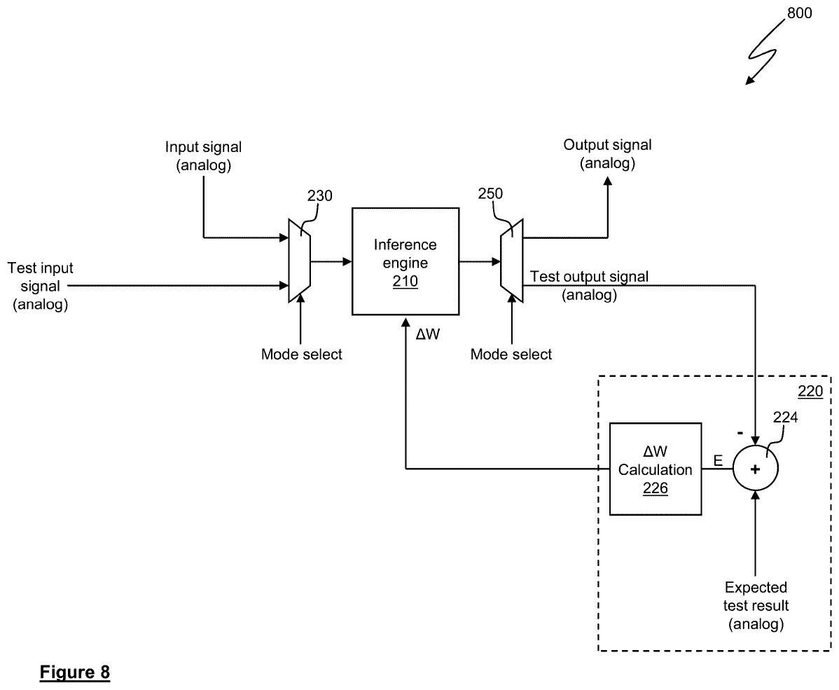

FIG. 8 is a schematic representation of an alternative signal processing system.

This alternative signal processing system, shown generally at 800 in FIG. 8, has many elements in common with the signal processing system 200 of FIG. 2. Such common elements are denoted by common reference numerals in FIGS. 2 and 8 and will not be described again in detail here.

The signal processing system 800 may be used in applications in which an analog input signal representing test or training data is supplied to the signal processing system 800 in the update mode of operation, and the output of the analog inference engine 210 is compared to an analog signal representing an expected output of the analog inference engine 210 to determine weight updates to be applied to the weights of the analog inference engine.

The signal processing system 800 thus omits the input DAC 240 that is present in the signal processing system 200 of FIG. 2, as such an input DAC is not necessary because an analog input signal is supplied to the signal processing system 800 in its update mode of operation.

Similarly, the signal processing system 800 omits the ADC 222 that is present in the signal processing system 200 of FIG. 2, as such an ADC is not necessary because the analog signal generated and output by the analog inference engine 210 in response to the test or training data input to the signal processing system 800 in the update mode is subtracted from an analog signal indicative of an expected output of the analog inference engine 210 to generate the error signal E. The error signal E is used by the processing block or module 226 (which may, in this example, comprise analog processing circuitry, or may comprise digital processing circuitry and an ADC for digitising the analog error signal E so that it can be processed by the digital processing circuitry) to generate the weight update signal ΔW for updating the weights of the analog inference engine 210 in the manner described above with reference to FIG. 4.

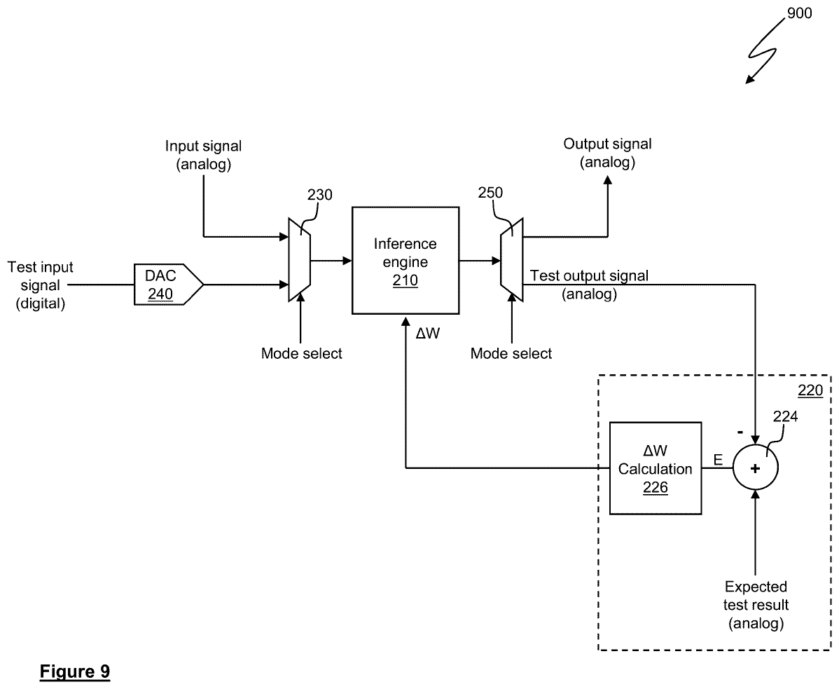

FIG. 9 is a schematic representation of an alternative signal processing system.

This alternative signal processing system, shown generally at 900 in FIG. 9, has many elements in common with the signal processing system 200 of FIG. 2. Such common elements are denoted by common reference numerals in FIGS. 2 and 9 and will not be described again in detail here.

The signal processing system 900 may be used in applications in which a digital input signal representing test or training data is supplied to the signal processing system 900 in the update mode of operation, and the output of the analog inference engine is compared to an analog signal representing an expected output of the analog inference engine 210 to determine weight updates to be applied to the weights of the analog inference engine.

The signal processing system 900 thus includes an input DAC 240 (of the kind described above with reference to the signal processing system 200 of FIG. 2), for converting the analog input signal representing the test or training data into an analog signal for input to the analog inference engine in the update mode of operation.

However, the signal processing system 900 omits the ADC 222, as such an ADC is not necessary because the analog signal generated and output by the analog inference engine 210 in response to the test or training data in the update mode is subtracted from an analog signal indicative of an expected output of the analog inference engine 210 to generate the error signal E. The error signal E is used by the processing block or module 226 (which may, in this example, comprise analog processing circuitry, or may comprise digital processing circuitry and an ADC for digitising the analog error signal E so that it can be processed by the digital processing circuitry) to generate the weight update signal ΔW for updating the weights of the analog inference engine 210, in the manner described above with reference to FIG. 4.

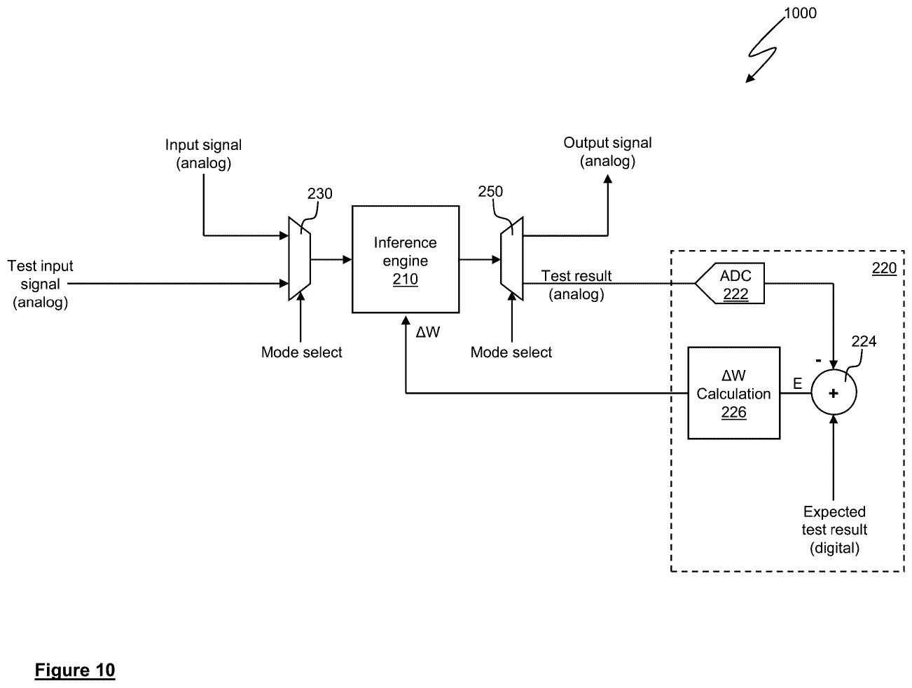

FIG. 10 is a schematic representation of an alternative signal processing system.

This alternative signal processing system, shown generally at 1000 in FIG. 10, has many elements in common with the signal processing system 200 of FIG. 2. Such common elements are denoted by common reference numerals in FIGS. 2 and 10 and will not be described again in detail here.

The signal processing system 1000 may be used in applications in which an analog input signal representing test or training data is supplied to the signal processing system 1000 in the update mode of operation, and a digitised version of the output of the analog inference engine 210 is compared to a digital signal representing an expected output of the analog inference engine 210 to determine weight updates to be applied to the weights of the analog inference engine.

The signal processing system 1000 thus omits the input DAC 240 that is present in the signal processing system 200 of FIG. 2, as such an input DAC is not necessary because an analog input signal is supplied to the signal processing system 800 in its update mode of operation.

However, the signal processing system 1000 includes an ADC 222 of the kind described above with reference to the signal processing system 200 of FIG. 2, which is used to convert the analog output signal generated by the analog inference engine 210 in response to the test or training data in the update mode into a digital signal, which is subtracted from a digital signal indicative of an expected output of the analog inference engine 210 to generate the error signal E. The error signal E is used by the processing block or module 226 to generate the weight update signal ΔW for updating the weights of the analog inference engine 210, in the manner described above with reference to FIG. 4.

In some examples, a signal processing system according to the present disclosure may be switchable between analog and digital input modes and between analog and digital output modes. For example, switching from a digital input mode to an analog input mode may be achieved by disabling or bypassing the input DAC 240 (in the signal processing system 200 of FIG. 2 and the signal processing system 900 of FIG. 9) or the input DAC 540 (in the signal processing system 500 of FIG. 5), while switching from a digital output mode to an analog mode may be achieved by disabling or bypassing the ADC 222 (in the signal processing system 200 of FIG. 2 and the signal processing system 1000 of FIG. 10) or the output ADC 550 (in the signal processing system 500 of FIG. 5).

In the example described above with reference to FIGS. 2, when the signal processing system 200 operates in its inference mode of operation, it receives an analog input signal and outputs an analog output signal, whereas in the example described above with reference to FIG. 5, when the signal processing system 500 operates in its inference mode of operation, it receives a digital input signal and outputs a digital output signal. However, in some applications or use cases, it may be desirable for a signal processing system operating in an inference mode of operation to be able to receive a digital input signal and output an analog output signal, or to receive an analog input signal and output a digital output signal.

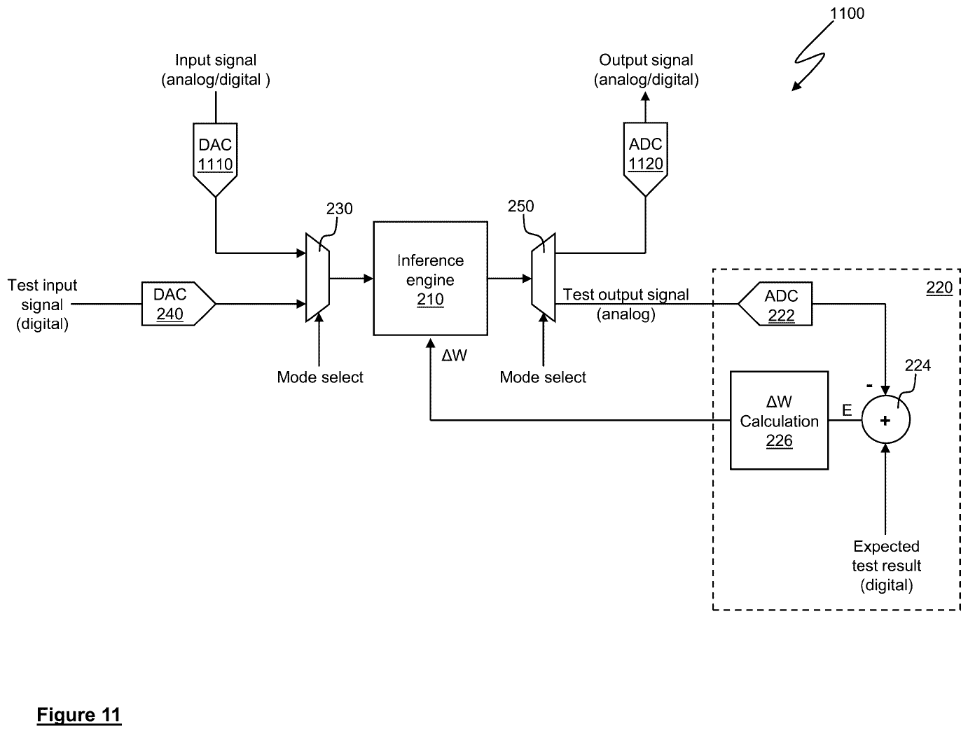

FIG. 11 is a schematic diagram showing a signal processing system according to the present disclosure that can be configured to receive an analog or digital input signal and to output an analog or digital signal in operation in an inference mode of operation.

The signal processing system, shown generally at 1100 in FIG. 11, has many elements in common with the signal processing system 200 of FIG. 2. Such common elements will not be described in detail here.

The signal processing system 1100 differs from the signal processing system 200 of FIG. 2 in that it includes an inference input DAC 1100 having an output coupled to the first input of the input multiplexer 230. The signal processing system 1100 further includes an output inference ADC 1120 having an input coupled to the first output of the output demultiplexer 250.

The inference input DAC 1110 is selectively operable, such that it can be activated or enabled when the signal processing system 1100 is required to process a digital input signal in an inference mode of operation, and deactivated or disabled when the signal processing system 1100 is required to process an analog input signal in the inference mode of operation. Similarly, the inference output ADC 1120 is selectively operable, such that it can be activated or enabled when the signal processing system 1100 is required to output a digital output signal in an inference mode of operation, and deactivated or disabled when the signal processing system 1100 is required to output a digital output signal in the inference mode of operation.

The provision of the selectively operable inference input DAC 1110 and the selectively operable inference output ADC 1120 enables the signal processing circuitry 1100 to be configured for different input and output signal permutations. For example, with the selectively operable inference input DAC 1110 and the selectively operable inference output ADC 1120 both activated or enabled, the signal processing system 1100 is capable, when operating in its inference mode of operation, of processing a “live” analog input signal to generate an analog output signal for use by an downstream analog element, in the manner described above with reference to FIG. 3.

Conversely, with the selectively operable inference input DAC 1110 and the selectively operable inference output ADC 1120 both deactivated or disabled, the signal processing system 1100 is capable, when operating in its inference mode of operation, of processing a “live” digital input signal to generate a digital output signal. In this configuration, the inference input DAC 1110 is operative to convert the digital input signal into an analog signal that can be processed by the analog inference engine 210, and the inference output ADC 1120 is operative to convert the analog output of the analog inference engine 210 into a digital signal for use by a downstream digital element.

With the selectively operable inference DAC 1110 activated or enabled and the selectively operable inference output ADC 1120 deactivated or disabled, the signal processing system 1100 is capable, when operating in its inference mode of operation, of processing a “live” digital input signal to generate an analog output signal. In this configuration, the inference input DAC 1110 is operative to convert the digital input signal into an analog signal that can be processed by the analog inference engine 210, and the analog output of the analog inference engine 210 is output to a downstream analog element. Such a configuration may be desirable, for example, in an application or use case in which a digital input signal is provided to the signal processing system 1100 and the analog output signal is supplied as an input to one or more downstream analog inference engines.

With the selectively operable inference DAC 1110 deactivated or disabled and the selectively operable inference output ADC 1120 activated or enabled, the signal processing system 1100 is capable, when operating in its inference mode of operation, of processing a “live” analog input signal to generate a digital output signal. In this configuration, the inference output ADC 1120 is operative to convert the analog output of the analog inference engine 210 into a digital signal for use by a downstream digital element.

In an alternative example, the inference input DAC 1110 and the inference output ADC 1120 may be permanently activated or enabled, and the signal processing system 1100 may include first bypass circuitry for selectively bypassing the inference input DAC 1110 when an analog input signal is provided in the inference mode of operation, and second bypass circuitry for selectively bypassing the inference output DAC 1120 when an analog output signal is required in the inference mode of operation. As will be appreciated by those of ordinary skill in the art, in such an arrangement the state of the first and second bypass circuitry defines the configuration of the signal processing system 1100. Thus, with the first bypass circuitry activated or enabled and the second bypass circuitry deactivated or disabled, the signal processing system 1100 can receive an analog input signal and output an analog signal, in operation in its inference mode of operation. With both the first bypass circuitry deactivated or disabled and the second bypass circuitry activated or enabled, the signal processing system 1100 can receive a digital input signal and output a digital signal, in operation in its inference mode of operation. With both the first bypass circuitry and the second bypass circuitry deactivated or disabled, the signal processing system 1100 can receive an analog input signal and output a digital output signal. With both the first bypass circuitry and the second bypass circuitry activated or enabled, the signal processing system 1100 can receive a digital input signal and output an analog output signal.

It will be appreciated by those of ordinary skill in the art that the signal processing system 1100 may be modified or adapted to suit specific applications or use case.

For example, for applications in which the “live” input signal will always be a digital input signal and an analog output signal will always be required in operation of the signal processing system 1100 in its inference mode of operation, the inference output ADC 1120 may be omitted, while the inference input DAC 1110 is retained.

Similarly, for applications in which the “live” input signal will always be an analog input signal and a digital output signal will always be required in operation of the signal processing system 1100 in its inference mode of operation, the inference input DAC 1110 may be omitted while the inference output ADC 1120 is retained.

For applications in which the “live” input signal will always be an analog input signal and an analog output signal will always be required in operation of the signal processing system 1100 in its inference mode of operation, both the inference input DAC 1110 and the inference output ADC 1120 may be omitted.

For applications in which the “live” input signal will always be a digital input signal and a digital output signal will always be required in operation of the signal processing system 1100 in its inference mode of operation, both the inference input DAC 1110 and the inference output ADC 1120 may be retained.

The signal processing systems of the present disclosure combine the low power consumption of an analog inference engine with the robust weight updating capabilities of a learning engine, making them ideally suited for edge processing applications such as wearable devices (e.g. smart watches, wearable health monitor and the like) and portable or battery-powered devices such as mobile telephones, tablet, notebook and laptop computers and the like.

For example, a signal processing system of the kind described herein may be used in a wearable health monitor such as a continuous glucose monitor or other wearable health monitoring device. The low-power analog inference engine ensures extended battery life, while the learning engine can efficiently update weights of the analog inference engine to adapt to individual user data, thus improving the accuracy and reliability of the device.

As another example, a signal processing system of the kind described herein may be integrated into a smart watch to enhance functionalities such as health monitoring, gesture recognition and contextual awareness. Again, the low-power analog inference engine ensures long battery life, while the learning engine can dynamically update the device's learning models.

As a further example, a signal processing system of the kind described herein may be used in a mobile telephone (or cellphone) for applications such as image and speech recognition, predictive text input, and adaptive user interfaces. The combination of low-power analog processing and efficient digital learning updates provides an optimal balance between performance and battery life.

As yet another example, a signal processing system of the kind described herein may be used in various edge computing devices where low power consumption and real-time processing are essential. This includes Internet of Things (IOT) devices, autonomous sensors, and embedded systems used in smart homes and industrial automation.

The signal processing systems of the present disclosure may be implemented in integrated circuitry, e.g. in one or more integrated circuits, or in discrete circuitry, or in any combination of integrated circuitry and discrete circuitry.

Features of a signal processing system according to the present disclosure are set out in the following paragraphs.

There is provided a system and method for generating an output signal based on a received input signal, comprising: an analog inference engine configured to process the input signal and generate an output signal; and a digital learning engine coupled with the analog inference engine, configured to update weight values of the analog inference engine; wherein the system is arranged to operate in: an inference mode wherein the analog inference engine processes the received input signal and generates the output signal, and an update mode wherein the digital learning engine generates test inputs for the analog inference engine, monitors for test outputs from the analog inference engine based on the test inputs, and updates the weights based on the generated test inputs and the monitored test outputs.

Preferably, the analog inference engine is arranged to perform analog signal processing of the input signal.

Preferably, the analog inference engine is implemented using programmable impedance elements. For example, using Resistive RAM (RRAM) or Charge-Trap Transistors (CTTs).

Preferably, the weight values of the analog inference engine are stored in NVRAM, e.g. using RRAM or CTTs.

Preferably, the digital learning engine updates the weights of the analog inference engine using Hinton's Forward-Forward technique, wherein: the digital learning engine calculates a goodness score per layer based on the outputs generated by the analog inference engine from real input data, and the digital learning engine updates the weight values based at least in part on the per layer goodness score.

Preferably, the digital learning engine uses learning data for a positive and negative desired output, processes it through the analog inference engine, and calculates a goodness score for these outputs; and the digital learning engine updates the weights to increase the goodness score for the positive data and decrease the goodness score for the negative data.

Preferably, the digital learning engine updates the weights of the analog inference engine using the Error Diffusion technique adapted for neural network weight updating, wherein: the digital learning engine calculates the error between the actual output and the desired output after processing an input through the analog inference engine; and the digital learning engine adjusts the weights at every layer by determining a global error and applying the error to all weights in the net.

Preferably, the system further comprises a Digital-to-Analog Converter (DAC) to convert digital test inputs from the digital learning engine into analog test inputs for the analog inference engine.

Preferably, the system further comprises an Analog-to-Digital Converter (ADC) to convert analog test outputs from the analog inference engine into digital test outputs for monitoring by the digital learning engine.

Preferably, the digital learning engine comprises a digital signal processor or other suitable processing unit.

Preferably, the system is configured to receive an analog input signal from an analog sensor or an output of a preceding analog neural network.

Preferably, the system is configured to receive a digital input signal from a digital sensor or a digital signal processor, further comprising a DAC to convert the digital input signal into an analog input signal for processing by the analog inference engine, wherein the DAC is multiplexed with test input data from the digital learning engine.

Preferably, the system is configured to generate an analog output signal for an analog transducer or further analog processing circuitry.

Preferably, the system is configured to generate a digital output signal, further comprising an ADC to convert the analog output of the analog inference engine into a digital output signal, wherein the ADC is multiplexed to send the digital output to the system output or the digital learning engine depending on the operational mode.

The signal processing systems described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, an Internet of Things (IOT) device, an autonomous sensors, an embedded system, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A signal processing system configured to receive an input signal and generate an output signal, the signal processing system comprising:
an analog inference engine; and
a learning engine coupled to the analog inference engine,
wherein the signal processing system is operable in a first mode of operation and a second mode of operation, wherein:
in the first mode of operation, the analog inference engine is operative to apply weights to the received input signal to generate the output signal; and
in the second mode of operation, the analog inference engine is operative to receive a test input signal and process the test input signal to generate a test output signal, and the learning engine is operative to update the weights of the inference engine based on the test output signal.

2. The signal processing system of claim 1, wherein the analog inference engine comprises an analog neural network.

3. The signal processing system of claim 2, wherein the analog inference engine is implemented with programmable impedance hardware elements.

4. The signal processing system of claim 3, wherein the programmable impedance hardware elements comprise resistive RAM elements, memristors, charge trap transistors or any combination thereof.

5. The signal processing system of claim 3, wherein impedances of the programmable impedance hardware elements act as the weights of the analog inference engine.

6. The signal processing system of claim 1, wherein the learning engine is operative to update the weights of the analog inference engine using an updating method comprising first and second forward passes.

7. The signal processing system of claim 6, wherein the updating method comprises:
in the first forward pass, generating, by the learning engine, a first goodness score for each layer of the analog inference engine based on an output generated by the analog inference engine from a first set of test input data; and
in the second forward pass, generating, by the learning engine, a second goodness score for each layer of the analog inference engine based on an output generated by the analog inference engine from a second set of test input data; and
updating, by the learning engine, the weights of each layer of the analog inference engine based on the first and second goodness scores.

8. The signal processing system of claim 7, wherein:
the first set of test input data comprises data for which the analog inference engine should generate a positive output; and
the second set of test input data comprises data for which the analog inference engine should generate a negative output, and.
wherein the learning engine is operative to update the weights of each layer of the analog inference engine to increase the first goodness score and decrease the second goodness score.

9. The signal processing system of claim 1, wherein the learning engine is operative to update the weights of the analog inference engine using an error diffusion technique.

10. The signal processing system of claim 9, wherein the learning engine is operative to:
determine weight updates based on a difference between an expected output of the analog inference engine for a test input and an actual output of the analog inference engine for the test input; and
apply the weight updates to weights of the analog inference engine.

11. The signal processing system of claim 1, further comprising a digital to analog converter (DAC) for converting a digital input signal to an analog input signal for processing by the analog inference engine.

12. The signal processing system of claim 11, further comprising an input multiplexer for selectively coupling an input of the DAC to either a test input signal source or a live input signal source according to the mode of operation of the signal processing system.

13. The signal processing system of claim 11, further comprising an input multiplexer for selectively coupling an input of the analog inference engine to either an output of the DAC or an analog input signal source according to the mode of operation of the signal processing system.

14. The signal processing system of claim 1, further comprising an analog to digital converter (ADC) for converting an analog output signal generated by the analog inference engine in response to an analog input signal into a digital output signal.

15. The signal processing system of claim 14, further comprising a demultiplexer for selectively coupling the output of the ADC to either the learning engine or a downstream component or system according to the mode of operation of the signal processing system.

16. The signal processing system of claim 1, wherein the learning engine comprises:
a subtractor operative, in the second mode of operation, to subtract a signal indicative of the test output signal from a signal indicative of an expected output of the analog inference engine responsive to receiving the test input signal to generate an error signal; and
a weight update processing block or module operative to generate a weight update to be applied to weights of the analog inference engine based on the error signal.

17. The signal processing system of claim 1, wherein the learning engine is operative to limit or restrict a magnitude of a weight update for updating the weights of the analog inference engine or to limit or restrict a rate at which the weights of the analog inference engine are updated.

18. An integrated circuit implementing the signal processing system of claim 1.

19. A host device comprising the signal processing system of claim 1.

20. A host device according to claim 19, wherein the host device comprises a wearable device, a wearable health monitor, a continuous glucose monitor, a smart watch, a mobile telephone, an Internet of Things (IoT) device, a sensor, an embedded system, a laptop, notebook, netbook or tablet computer, a gaming device, a games console, a controller for a games console, a virtual reality (VR) or augmented reality (AR) device, a portable audio player, a portable device, an accessory device for use with a laptop, notebook, netbook or tablet computer, a gaming device, a games console a VR or AR device, a mobile telephone, a portable audio player or other portable device.
